(19) United States
(12) Patent Application Publication
(10) Pub. No.: US 2009/0199002 A1
(43) Pub. Date: Aug. 6, 2009

(54) Methods and Systems for Shortened Hash Authentication and Implicit Session Key Agreement

(75) Inventor: David Lee Erickson, San Jose, CA (US)

Correspondence Address: MARTINE PENILLA & GENCARELLA, LLP, 710 LAKEWAY DRIVE, SUITE 200, SUNNYVALE, CA, 94085, US

(73) Assignee: iControl, Inc., Santa Clara, CA (US)

(21) Appl. No.: 12/366,636

(22) Filed: Feb. 5, 2009

Related U.S. Application Data
(60) Provisional application No. 61/026,465, filed on Feb. 5, 2008.
(60) Provisional application No. 61/026,728, filed on Feb. 6, 2008.

(51) Int. Cl. H04L 9/32

(52) U.S. Cl. 713/171; 713/168

(57) ABSTRACT

A first hash result is generated at a client system in accordance with hash input parameters known to the client system. A second hash result is generated at a server system in accordance with hash input parameters known to the server system. Each of the first hash result and the second hash result is truncated in a same manner. The truncated first hash result is transmitted from the client system to the server system. The truncated first hash result as transmitted to the server system is compared with the truncated second hash result generated at the server system. Equality between the truncated first hash result as transmitted to the server system and the truncated second hash result generated at the server system authenticates the client system to the server system.

### CLAIM OF PRIORITY

This application claims priority under 35 U.S.C. 119(e) to U.S. Provisional Patent Application No. 61/026,465, filed Feb. 5, 2008, entitled “Shortened Hash Authentication,” and to U.S. Provisional Patent Application No. 61/026,728, filed Feb. 6, 2008, entitled “Inherent Session Key Agreement.” The disclosures of the above-identified provisional patent applications are respectively incorporated herein by reference.

### BACKGROUND

Secure communication between a client and a server is often required in modern telecommunication systems. Communication security involves identifying and authentication of a client to a server. In general networking systems, complex identification and authentication methods may be deployed. However, such complex security methods typically require substantial computing and power resources on both the client side and server side, as well as substantial communication bandwidth to convey identification and authentication credentials, which may be lengthy. In situations where one or both of the client and server systems are limited on computing and/or power resources, or where a limited communication bandwidth exists between the client and server systems, it is desirable to have a strong identification and authentication security capability that does not compromise system or network operability.

### SUMMARY

In one embodiment, a method is disclosed for performing a shortened hash authentication. The method includes an operation for generating a first hash result at a client system in accordance with hash input parameters known to the client system. A second hash result is also generated at a server system in accordance with hash input parameters known to the server system. Each of the first hash result and the second hash result is truncated in a same manner. The method further includes transmitting the truncated first hash result from the client system to the server system. The truncated first hash result as transmitted to the server system is compared with the truncated second hash result generated at the server system. Equality between the truncated first hash result as transmitted to the server system and the truncated second hash result generated at the server system authenticates the client system to the server system.

In another embodiment, a method is disclosed for performing a shortened hash authentication. In the method, a secret code is stored on each of a client system and a server system. The secret code is identical on each of the client and server systems. The method also includes an operation for generating a nonce code specific to a given authentication process. The nonce code is provided to both the client system and the server system. The secret code and the nonce code are combined to generate a local code word at each of the client system and server system. Each generated local code word is processed through a hashing algorithm to generate a local hash result at each of the client system and the server system. Also, at each of the client system and server system, each local hash result is truncated to obtain a client-generated authentication code and a server-generated authentication code. The client-generated authentication code is transmitted to the server system. The method further includes an operation for comparing the client-generated authentication code to the server-generated authentication code at the server system. Equality between the client-generated authentication code and the server-generated authentication code authenticates the client system to the server system.

In another embodiment, a system for performing a shortened hash authentication is disclosed. The system includes a client defined to generate a first hash result in accordance with hash input parameters known to the client. The client is also defined to truncate the first hash result to obtain a client-generated authentication code. The system also includes a server defined to generate a second hash result in accordance with hash input parameters known to the server. The server is also defined to truncate the second hash result to obtain a server-generated authentication code. The client is defined to transmit the client-generated authentication code to the server. The server is defined to receive the client-generated authentication code and compare the client-generated authentication code to the server-generated authentication code. Equality between the client-generated and server-generated authentication codes authenticates the client to the server.

In another embodiment, a method is disclosed for implicit session key agreement. The method includes an operation for storing a secret code on each of a client system and a server system. The secret code is identical on each of the client and server systems. The method also includes an operation for generating a nonce code specific to a given authentication process. The nonce code is provided to both the client system and the server system. The method further includes an operation for combining the secret code and the nonce code to generate a local code word at each of the client system and server system. Each generated local code word is processed through a hashing algorithm to generate a local hash result at each of the client system and the server system. The method further includes an operation for using the local hash result at each of the client system and the server system as an implicit session key for data communication between the client and server systems.

Other aspects and advantages of the invention will become more apparent from the following detailed description, taken in conjunction with the accompanying drawings, illustrating by way of example the present invention.

### BRIEF DESCRIPTION OF THE DRAWINGS

FIG. 1 shows a flowchart of a method for performing a shortened hash authentication, in accordance with one embodiment of the present invention;

FIG. 2 shows a shortened hash authentication process over a simplex channel, in accordance with one embodiment of the present invention;

FIG. 3 shows a comparison between the shortened hash authentication method over simplex and duplex channels, in accordance with one embodiment of the present invention;

FIG. 4 shows an example shortened hash authentication using concatenation of the secret code and nonce code, in accordance with one embodiment of the present invention;

FIG. 5 shows an example shortened hash authentication using algebraic addition of the secret code and nonce code, in accordance with one embodiment of the present invention;

FIG. 6 shows a shortened hash authentication process over a simplex channel with dynamic process parameters, in accordance with one embodiment of the present invention;

FIG. 7 shows an example shortened hash authentication using algebraic addition of the secret code and nonce code with dynamic parameter settings, in accordance with one embodiment of the present invention;

FIG. 8 shows a flowchart of a method for performing a shortened hash authentication, in accordance with one embodiment of the present invention;

FIG. 9 shows a method for performing implicit session key agreement with a simplex channel, in accordance with one embodiment of the present invention;

FIG. 10 shows a comparison of the simplex and duplex embodiments in the implicit session key agreement methods, in accordance with one embodiment of the present invention;

FIG. 11 shows an example implicit session key agreement implementation, in accordance with one embodiment of the present invention;

FIG. 12 shows another example implicit session key agreement implementation, in accordance with one embodiment of the present invention;

FIG. 13 shows an implicit session key agreement process with dynamic process parameters, in accordance with one embodiment of the present invention;

FIG. 14 shows an example in which the method of combination and hash algorithm are dynamically specified, in accordance with one embodiment of the present invention; and

FIG. 15 shows a flowchart of a method for implicit session key agreement, in accordance with one embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

Shortened hash authentication methods are disclosed herein for strong authentication security while reducing the communication burden between two entities, such as between a client and a server. The shortened hash authentication methods are well-suited for application in high-security, low-bandwidth communication channels in distributed networks. Moreover, the shortened hash authentication methods disclosed herein satisfy identification and authentication requirements of low-bandwidth networks, which are utilized in low-cost and/or low-power applications.

Shortened Hash Authentication

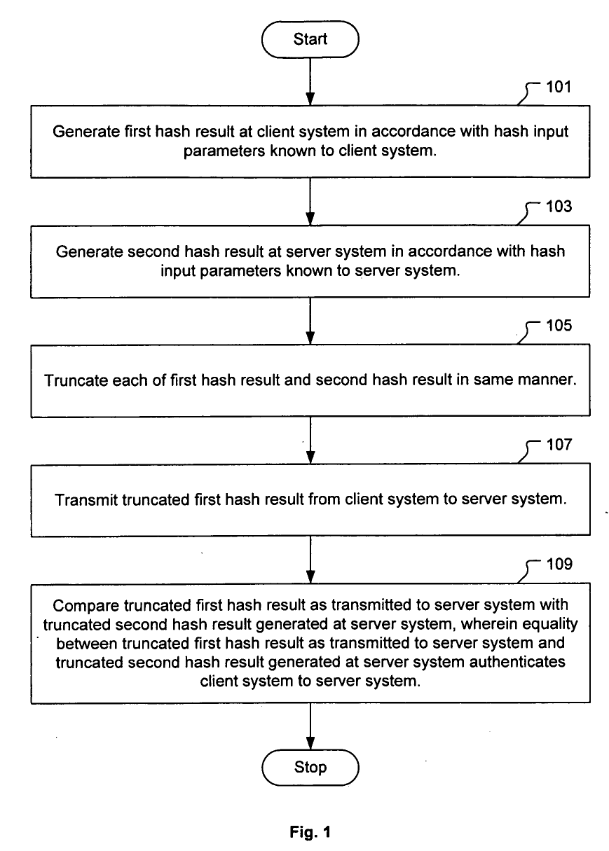

A shortened hash authentication method is disclosed herein for strong authentication of a client to a server at a reduced communication channel bandwidth. The shortened hash authentication method strongly secures distributed communication networks while minimizing an impact to overall communication channel bandwidth. FIG. 1 shows a flowchart of a method for performing a shortened hash authentication, in accordance with one embodiment of the present invention. The method includes an operation 101 for generating a first hash result at a client system in accordance with hash input parameters known to the client system. An operation 103 is also performed to generate a second hash result at a server system in accordance with hash input parameters known to the server system. In an operation 105, each of the first hash result and the second hash result is truncated in a same manner.

The method also includes an operation 107 for transmitting the truncated first hash result from the client system to the server system. An operation 109 is then performed to compare the truncated first hash result as transmitted to the server system with the truncated second hash result generated at the server system. If the comparison yields equality between the truncated first hash result as transmitted to the server system and the truncated second hash result generated at the server system, the client system is authenticated to the server system. Otherwise, the client system is not authenticated to the server system.

In one embodiment, the hash input parameters known to the client system include a client code word representing a combination of a secret code and a nonce code as known to the client system. Also, in this embodiment, the hash input parameters known to the server system include a server code word representing a combination of a secret code and a nonce code known to the server system. In one embodiment, the secret code known to the client system and the secret code known to the server system are identical and are stored on the client and server systems prior to authentication. In various embodiments, the secret code can take different forms, so long as the secret code is identical at both the client system and server system. In one exemplary embodiment, the secret code is an ASCII text phrase.

The nonce code is uniquely generated for each authentication process. It should be understood that because the nonce code varies from one authentication process to another, combination of the secret code and nonce code to generate the code word serves to prevent a successful malevolent decoding of the code word in one authentication process from being used in subsequent authentication processes. In one embodiment, the nonce code is derived from a monotonic data source, such that the nonce code will not repeat itself. In one embodiment, the nonce code is a current time stamp. Because the code word includes a private portion, i.e., the shared secret code, the nonce code may be transmitted in public view between the client and server systems. The same nonce code needs to be used by each of the client and server systems in generating their respective code words.

In one embodiment, the nonce code is generated at the client system and is transmitted from the client system to the server system. This embodiment may be utilized when a simplex communication channel exists between the client system and the server system. In such a simplex communication channel, uni-directional communication is possible from the client system to the server system. In another embodiment, the nonce code can be generated at the server system and can be transmitted from the server system to the client system. This embodiment may be utilized when a duplex communication channel exists between the client system and the server system. In such a duplex communication channel, bi-directional communication is possible between the client and server systems. It should be appreciated that greater computing resources of the server system, as compared to the client system, can be advantageously utilized to generate the nonce code when the duplex communication channel is present. In another embodiment, the nonce code is generated independently at each of the client system and server system. In this embodiment, the nonce code is generated based on identical information that is independently known to both the client system and server system, such that the nonce code known to the client system is identical to the nonce code known to the server system.

As previously mentioned, the client and server code words represent a combination of the secret code and the nonce code as known to the client and server systems, respectively. In various embodiments, the secret code and the nonce code can be combined in different ways to generate the client and server code words, so long as the client and server system use the identical method for combining the secret code and nonce code. For example, in one embodiment, at each of the client and server systems, the secret code and nonce code can be combined by concatenation to form the code word. In this embodiment, the concatenation may be in any order, so long as the same concatenation order is utilized at both the client and server systems.

In another embodiment, at each of the client and server systems, the secret code and nonce code can be combined in an algebraic manner to form the code word. For example, a bit-wise addition of the binary forms of the secret code and nonce code may be performed to generate the code word. In other embodiments, the algebraic combination of the secret code and nonce code may include bit-wise subtraction, bit-wise multiplication, bit-wise division, or essentially any other bit-wise computation, so long as the same algebraic combination method is utilized at both the client and server systems. The method for combining the secret code and nonce code may be known a priori and encoded in the design in various embodiments, or may be dynamically selected by information shared in common between the client and server systems. This shared information may be encoded within the message, implicit in the connection address or port number or in some other data, or may be implicitly or explicitly available in some other manner to the client and server systems.

It should be understood that the identical hashing algorithm is used to generate the first hash result at the client system and the second hash result at the server system. In one embodiment, both the client and server systems are pre-loaded with information specifying the required hashing algorithm and its associated parameters, such as the hash seed to be used. In another embodiment, the hashing algorithm and its associated parameters may be dynamically determined by each of the client and server systems based on information shared in common between the client and server systems. For example, the hashing algorithm and its associated parameters may be encoded within the message, implicit in the connection address or port number or in some other data, or may be implicitly or explicitly available in some other manner to the client and server systems.

The method of FIG. 1 can further include an operation for specifying a truncation size for both the first hash result and the second hash result. The truncation size is specified based on a bandwidth available for transmission of the truncated first hash result and a probability of malevolent decoding of the truncated first hash result. In one embodiment, the truncation size is pre-defined in both the client and server systems. In another embodiment, the truncation size may be known a priori and encoded in the design, or may be dynamically selected by information shared in common between the client and server systems. In yet another embodiment, the truncation size may be encoded within the message, implicit in the connection address or port number or in some other data, or may be implicitly or explicitly available in some other manner to the client and server systems. It should be understood that the truncation size is identical for both the client and server systems.

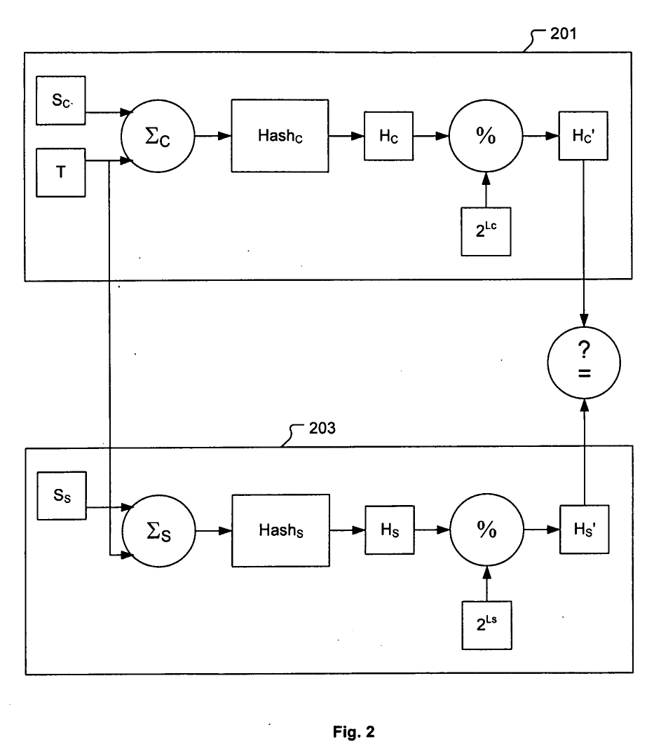

FIG. 2 shows a shortened hash authentication process over a simplex channel, in accordance with one embodiment of the present invention. The client 201 combines the client's secret code (S_{C}) with a monotonic nonce code (T_{C}) to generate a client code word (Σ_{C}), which is submitted to a selected hash algorithm (Hash_{C}) to produce a long authentication code (H_{C}). This long authentication code (H_{C}) is truncated to a shorter client-generated authentication code (H_{C}c′) for efficient transmission from the client to the server. Truncation of the long authentication code (H_{C}) is mathematically equivalent to the operation H_{C} mod 2^{L}_{C}, where L_{C} is the specified truncation size. The client 201 transmits the nonce code (T_{C}) and the client-generated authentication code (H_{C}′) to the server 203.

The server 203 combines the server's secret code (S_{S}), where (S_{S}=S_{C}), with the shared monotonic nonce code (T_{C}) to generate a server code word (Σ_{S}), which is submitted to a selected hash algorithm (Hash_{S}), where (Hash_{S}=Hash_{C}), to produce a long authentication code (H_{S}). This long authentication code (H_{S}) is truncated to a shorter server-generated authentication code (H_{S}′). Truncation of the long authentication code (H_{S}) is mathematically equivalent to the operation H_{S} mod 2^{L}_{S}, where (L_{C}=L_{S}). The server 203 compares the client-generated authentication code (H_{C}′) to the server-generated authentication code (H_{S}′) and declares a successful authentication of the client 201 to the server 203 if H_{S}′=H_{C}′.

The hashing algorithm is chosen such that when subjected to a brute force attack method, the expected number of attempts required to discover the mutual secret is 2^{|H}_{C}^{|-1}, where |H_{C}| is the length of the long authentication code H_{C}. Some hashing algorithms have less cryptographic strength, and research on a published hashing algorithm generally reduces the cryptographic strength over time as new methods of cryptographic attack are discovered. The shortened hash authentication method is defined such that the probability of successfully guessing the truncated authentication code is at most 2^{1-|H}_{C}^{′|}, where |H_{C}′| is the length of the truncated authentication code word H_{C}′. Since the probability of falsely authenticating two messages is limited to 2^{1-2|H}_{C}^{′|}, the probability of falsely authenticating (n) messages is limited to 2^{1-n|H}_{C}^{′|} or 2^{1-|}_{C}^{|}, whichever is less. Therefore, the shortened hash authentication method provides conventional cryptographic strength in the long term while offering a significant reduction in required authentication code transmission bandwidth.

Based on the foregoing, it should be understood that the authentication code (H) originates from a strong hash algorithm and is truncated (H′) to minimize the bandwidth burden on low-bandwidth channels. Although the probability of anticipating the correct authentication code is approximately 2^{|H′|} (where |H′| is the length of H′), the ability to determine the secret code remains approximately 2^{|H|} (assuming brute force attack, and hashing algorithm strength variability), where |H|>>|H′|. Unless the mutual secret can be discovered, the probability of reliably compromising authentication is 2^{|H|}, and the average expected compromise rate is 2^{|H′|}, which can be adjusted to the specific security requirements of the application.

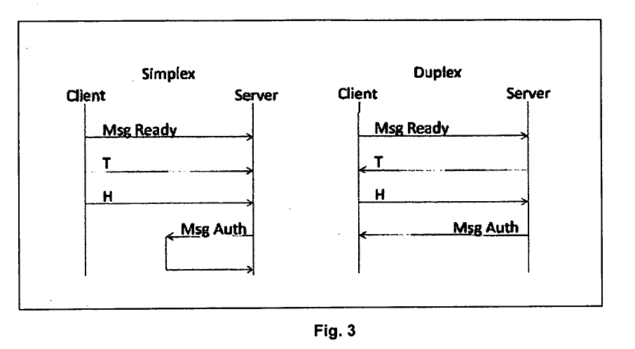

FIG. 3 shows a comparison between the shortened hash authentication method over simplex and duplex channels, in accordance with one embodiment of the present invention. In the simplex embodiment, the client produces the nonce code (T) and provides it to the server. In the duplex embodiment, the server produces and shares the nonce code (T) as needed when the client is ready to transmit. The simplex embodiment may be used where simplex channels or excessive channel latency is present. The duplex embodiment may be used where the client cannot reliably produce a monotonic nonce code (T) or when the server can produce the monotonic nonce code (T) more conveniently or for less cost.

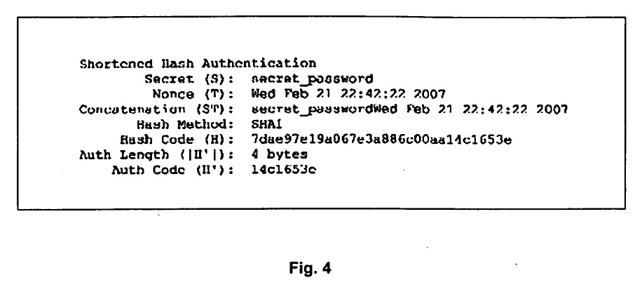

FIG. 4 shows an example shortened hash authentication using concatenation of the secret code (S) and nonce code (T), in accordance with one embodiment of the present invention. Each symbol is drawn from the set of {0 . . . 255} and may be ASCII or other coding for the convenience of the implementation. In this illustration, the code word (ST) is appended with 0's until the total length is 128 bits long, then the code word (ST) is submitted to the SHA-1 hashing algorithm to produce a 16-byte value for the hash code (H), of which 4 bytes are retained for the truncated authentication code (H′).

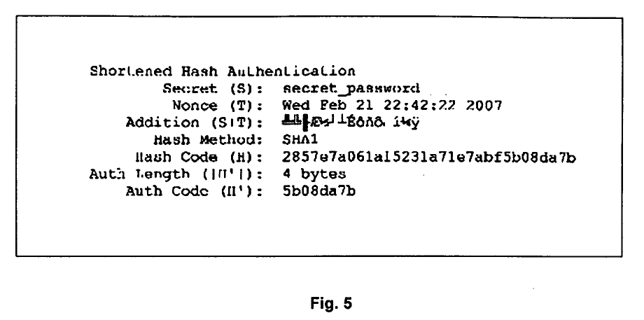

FIG. 5 shows an example shortened hash authentication using algebraic addition of the secret code (S) and nonce code (T), in accordance with one embodiment of the present invention. More specifically, the nonce code (T) is added to the secret code (S), byte-by-byte (modulus 256). Each symbol is drawn from the set of {0 . . . 255} and may be ASCII or other coding for the convenience of the implementation. In this example embodiment, the code word (S+T) is appended with 0's until the total length is 128 bits long, then the code word (S+T) is submitted to the SHA-1 hashing algorithm to produce a 16-byte value for the hash code (H), of which 4 bytes are retained for the truncated authentication code (H′).

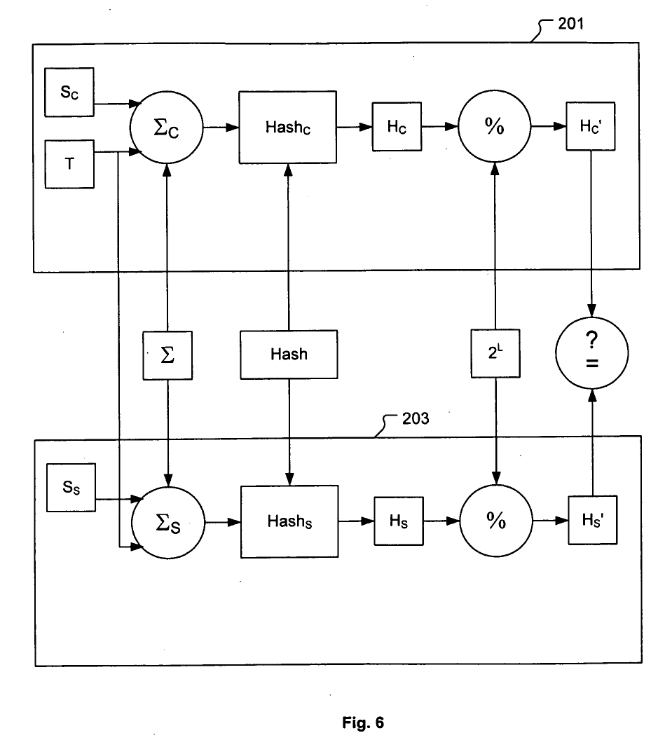

FIG. 6 shows a shortened hash authentication process over a simplex channel with dynamic process parameters, in accordance with one embodiment of the present invention. The method (Σ) for combining the secret code (S) and the nonce code (T) is a dynamic parameter that can be set for both the client 201 and server 203. The hashing algorithm and associated parameters (Hash) is a dynamic parameter that can be set for both the client 201 and server 203. The truncation size (2^{L}) and offset is also a dynamic parameter that can be set for both the client 201 and server 203.

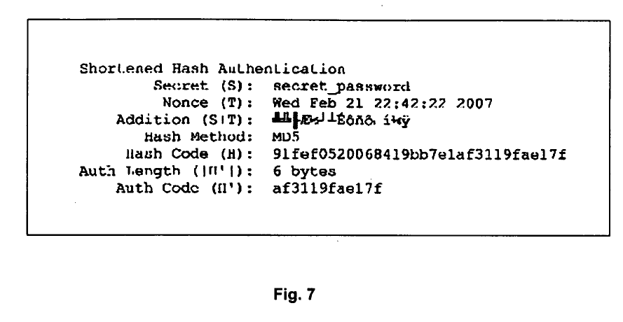

FIG. 7 shows an example shortened hash authentication using algebraic addition of the secret code (S) and nonce code (T) with dynamic parameter settings, in accordance with one embodiment of the present invention. Each symbol is drawn from the set of {0 . . . 255} and may be ASCII or other coding for the convenience of the implementation. In this example embodiment, the code word (S+T) is appended with 0's until the total length is 128 bits long, then the code word (S+T) is submitted to an MD5 hashing algorithm to produce a 16-byte value for the hash code (H), of which 6 bytes are retained for the truncated authentication code (H′). Thus, in this example embodiment, the combination method (Σ) is set as algebraic addition, the hashing algorithm (Hash) is set as MD5, and the truncation size (2^{L}) is set as 6 bytes.

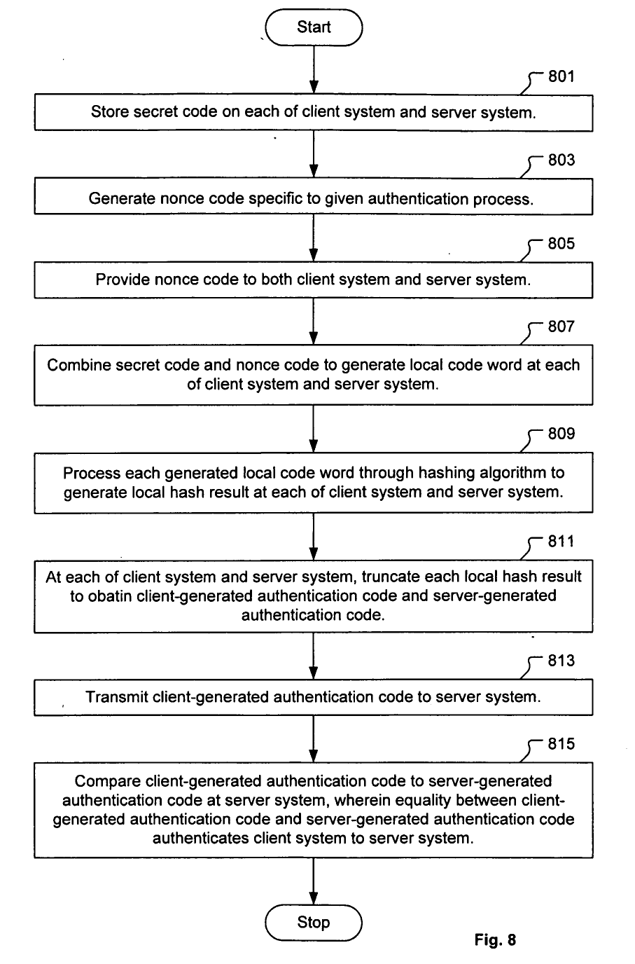

FIG. 8 shows a flowchart of a method for performing a shortened hash authentication, in accordance with one embodiment of the present invention. The method includes an operation 801 for storing a secret code on each of a client system and a server system. The secret code is identical on each of the client and server systems. The method also include an operation 803 for generating a nonce code specific to a given authentication process. The nonce code is uniquely generated for each authentication process based on a monotonically changing source. In one embodiment, the nonce code is a time stamp. An operation 805 is performed to provide the nonce code to both the client system and the server system. In one embodiment, the nonce code is generated at the client system and is transmitted in public view from the client system to the server system. In another embodiment, the nonce code is generated at the server system and is transmitted in public view from the server system to the client system.

The method continues with an operation 807 to combine the secret code and the nonce code to generate a local code word at each of the client system and server system. In one embodiment, combining the secret code and the nonce code is performed by either a concatenation or an algebraic combination and is performed in an identical manner at each of the client system and server system. An operation 809 is then performed to process each generated local code word through a hashing algorithm to generate a local hash result at each of the client system and the server system. An operation 811 is then performed to truncate each local hash result to obtain a client-generated authentication code and a server-generated authentication code, at each of the client system and server system, respectively. In one embodiment, an operation is performed to specify a common set of hashing parameters and truncation parameters to be used at each of the client system and server system. The hashing parameters may include a hashing algorithm identification and a hash seed, among other parameters. The truncation parameters may include a truncation length and a truncation offset, among other parameters.

The method further includes an operation 813 for transmitting the client-generated authentication code to the server system. Then, an operation 815 is performed to compare the client-generated authentication code to the server-generated authentication code at the server system. Equality between the client-generated authentication code and the server-generated authentication code authenticates the client system to the server system.

As discussed above, the shortened hash authentication methods disclosed herein can be implemented in many different ways. A number of exemplary embodiments are briefly identified below. It should be understood, however, that the generalized shortened hash authentication method as disclosed herein can be implemented in various ways that may not be explicitly identified in the exemplary embodiments below.

Shortened Hash Authentication—Simplex Channel

In this embodiment, the client combines a shared secret and a monotonic nonce to generate a client code word, submits the client code word to a hashing algorithm, and truncates the result to obtain the client authentication code. The client transmits the monotonic nonce to the server. The server similarly combines the privately shared secret and the public monotonic nonce to generate a server code word, submits the server code word to the same hashing algorithm, and truncates the result to obtain a server authentication code. If the client and sever authentication codes exactly match, the client identity is authenticated by the server. Otherwise, the server should reject the client credentials.

Shortened Hash Authentication—Duplex Channel

In this embodiment, the monotonic nonce is produced by the server and is transmitted to the client. The client combines a shared secret and a monotonic nonce to generate a client code word, submits the client code word to a hashing algorithm, and truncates the result to obtain the client authentication code. The server similarly combines the privately shared secret and the public monotonic nonce to generate a server code word, submits the server code word to the same hashing algorithm, and truncates the result to obtain a server authentication code. If the client and sever authentication codes exactly match, the client identity is authenticated by the server. Otherwise, the server should reject the client credentials.

Shortened Hash Authentication—Synchronized Channel

In this embodiment, the monotonic nonce is inherently known to both the client and server and is not explicitly transmitted. The client combines a shared secret and the monotonic nonce to generate a client code word, submits the client code word to a hashing algorithm, and truncates the result to obtain the client authentication code. The server similarly combines the privately shared secret and the public monotonic nonce to generate a server code word, submits the server code word to the same hashing algorithm, and truncates the result to obtain a server authentication code. If the client and sever authentication codes exactly match, the client identity is authenticated by the server. Otherwise, the server should reject the client credentials.

Shortened Hash Authentication—Concatenated Codes, Simplex Channel

This embodiment is a particular variant of the above-described Simplex Channel embodiment in which the shared secret and monotonic nonce are concatenated, in any order, and with optional padding codes to obtain a canonical code length. The monotonic nonce is produced by the client and transmitted to the server.

Shortened Hash Authentication—Concatenated Codes Duplex Channel

This embodiment is a particular variant of the above-described Duplex Channel embodiment in which the shared secret and monotonic nonce are concatenated, in any order, and with optional padding codes to obtain a canonical code length. The monotonic nonce is produced by the server and transmitted to the client.

Shortened Hash Authentication—Concatenated Codes, Synchronized Channel

This embodiment is a particular variant of the above-described Synchronized Channel embodiment in which the shared secret and monotonic nonce are concatenated, in any order, and with optional padding codes to obtain a canonical code length. The monotonic nonce is inherently known to both the client and server and is not explicitly transmitted.

Shortened Hash Authentication—Algebraic Codes, Simplex Channel

This embodiment is a particular variant of the above-described Simplex Channel embodiment in which the shared secret and monotonic nonce are combined by algebraic operations including but not limited to addition, multiplication or division, in any order, and with optional padding codes to obtain a canonical code length. The monotonic nonce is produced by the client and transmitted to the server.

Shortened Hash Authentication—Algebraic Codes, Duplex Channel

This embodiment is a particular variant of the above-described Duplex Channel embodiment in which the shared secret and monotonic nonce are combined by algebraic operations including but not limited to addition, multiplication or division, in any order, and with optional padding codes to obtain a canonical code length. The monotonic nonce is produced by the server and transmitted to the client.

Shortened Hash Authentication—Algebraic Codes, Synchronized Channel

This embodiment is a particular variant of the above-described Synchronized Channel embodiment in which the shared secret and monotonic nonce are combined by algebraic operations including but not limited to addition, multiplication or division, in any order, and with optional padding codes to obtain a canonical code length. The monotonic nonce is inherently known to both the client and server and is not explicitly transmitted.

Shortened Hash Authentication—General Codes, Simplex Channel

This embodiment is a particular variant of the above-described Simplex Channel embodiment in which the shared secret and monotonic nonce are combined by any operation with output dependent upon both the secret and nonce, in any order, and with optional padding codes to obtain a canonical code length. The monotonic nonce is produced by the client and transmitted to the server.

Shortened Hash Authentication—General Codes, Duplex Channel

This embodiment is a particular variant of the above-described Duplex Channel embodiment in which the shared secret and monotonic nonce are combined by any operation with output dependent upon both the secret and nonce, in any order, and with optional padding codes to obtain a canonical code length. The monotonic nonce is produced by the server and transmitted to the client.

Shortened Hash Authentication—General Codes, Synchronized Channel

This embodiment is a particular variant of the above-described Synchronized Channel embodiment in which the shared secret and monotonic nonce are combined by any operation with output dependent upon both the secret and nonce, in any order, and with optional padding codes to obtain a canonical code length. The monotonic nonce is inherently known to both the client and server and is not explicitly transmitted.

Shortened Hash Authentication—Dynamic Parameters, Concatenated Codes, Simplex Channel

This embodiment is a particular variant of the above-described Simplex Channel embodiment in which the shared secret and monotonic nonce are concatenated, in any order, and with optional padding codes to obtain a canonical code length. The monotonic nonce is produced by the client and transmitted to the server. One or more hashing and reduction parameters including but not limited to the hashing algorithm, hash seed, truncated code length and offset, and combination method are transmitted so that the server and client implementations dynamically match.

Shortened Hash Authentication—Dynamic Parameters, Concatenated Codes, Duplex Channel

This embodiment is a particular variant of the above-described Duplex Channel embodiment in which the shared secret and monotonic nonce are concatenated, in any order, and with optional padding codes to obtain a canonical code length. The monotonic nonce is produced by the server and transmitted to the client. One or more hashing and reduction parameters including but not limited to the hashing algorithm, hash seed, truncated code length and offset, and combination method are transmitted so that the server and client implementations dynamically match.

Shortened Hash Authentication—Dynamic Parameters Concatenated Codes, Synchronized Channel

This embodiment is a particular variant of the above-described Synchronized Channel embodiment in which the shared secret and monotonic nonce are concatenated, in any order, and with optional padding codes to obtain a canonical code length. The monotonic nonce is inherently known to both the client and server and is not explicitly transmitted. One or more hashing and reduction parameters including but not limited to the hashing algorithm, hash seed, truncated code length and offset, and combination method are transmitted so that the server and client implementations dynamically match.

Shortened Hash Authentication—Dynamic Parameters, Algebraic Codes, Simplex Channel

This embodiment is a particular variant of the above-described Simplex Channel embodiment in which the shared secret and monotonic nonce are combined by algebraic operations including but not limited to addition, multiplication or division, in any order, and with optional padding codes to obtain a canonical code length. The monotonic nonce is produced by the client and transmitted to the server. One or more hashing and reduction parameters including but not limited to the hashing algorithm, hash seed, truncated code length and offset, and combination method are transmitted so that the server and client implementations dynamically match.

Shortened Hash Authentication—Dynamic Parameters, Algebraic Codes, Duplex Channel

This embodiment is a particular variant of the above-described Duplex Channel embodiment in which the shared secret and monotonic nonce are combined by algebraic operations including but not limited to addition, multiplication or division, in any order, and with optional padding codes to obtain a canonical code length. The monotonic nonce is produced by the server and transmitted to the client. One or more hashing and reduction parameters including but not limited to the hashing algorithm, hash seed, truncated code length and offset, and combination method are transmitted so that the server and client implementations dynamically match.

Shortened Hash Authentication—Dynamic Parameters, Algebraic Codes, Synchronized Channel

This embodiment is a particular variant of the above-described Synchronized Channel embodiment in which the shared secret and monotonic nonce are combined by algebraic operations including but not limited to addition, multiplication or division, in any order, and with optional padding codes to obtain a canonical code length. The monotonic nonce is inherently known to both the client and server and is not explicitly transmitted. One or more hashing and reduction parameters including but not limited to the hashing algorithm, hash seed, truncated code length and offset, and combination method are transmitted so that the server and client implementations dynamically match.

Shortened Hash Authentication—Dynamic Parameters General Codes, Simplex Channel

This embodiment is a particular variant of the above-described Simplex Channel embodiment in which the shared secret and monotonic nonce are combined by any operation with output dependent upon both the secret and nonce, in any order, and with optional padding codes to obtain a canonical code length. The monotonic nonce is produced by the client and transmitted to the server. One or more hashing and reduction parameters including but not limited to the hashing algorithm, hash seed, truncated code length and offset, and combination method are transmitted so that the server and client implementations dynamically match.

Shortened Hash Authentication—Dynamic Parameters General Codes Duplex Channel

This embodiment is a particular variant of the above-described Duplex Channel embodiment in which the shared secret and monotonic nonce are combined by any operation with output dependent upon both the secret and nonce, in any order, and with optional padding codes to obtain a canonical code length. The monotonic nonce is produced by the server and transmitted to the client. One or more hashing and reduction parameters including but not limited to the hashing algorithm, hash seed, truncated code length and offset, and combination method are transmitted so that the server and client implementations dynamically match.

Shortened Hash Authentication—Dynamic Parameters, General Codes, Synchronized Channel

This embodiment is a particular variant of the above-described Synchronized Channel embodiment in which the shared secret and monotonic nonce are combined by any operation with output dependent upon both the secret and nonce, in any order, and with optional padding codes to obtain a canonical code length. The monotonic nonce is inherently known to both the client and server and is not explicitly transmitted. One or more hashing and reduction parameters including but not limited to the hashing algorithm, hash seed, truncated code length and offset, and combination method are transmitted so that the server and client implementations dynamically match.

Implicit Session Key Agreement

Principles of the shortened hash authentication methods described above can also be applied in a method for implicit session key agreement, as described below. The method for implicit session key agreement provides for strong session key agreement security while reducing the communication burden between two entities, i.e., between a client and a server. The implicit session key agreement method is well-suited for application in high-security, low-bandwidth communication channels in distributed networks where low cost and low power consumption are required. Also, session keys generated through the implicit session key agreement method may be shared with third parties for the duration of a session or when securing other sessions, and without compromising the secret code used to generate the session key.

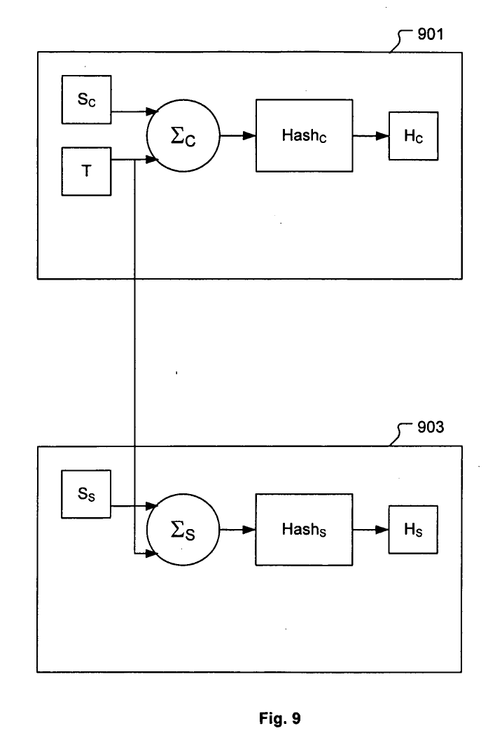

FIG. 9 shows a method for performing implicit session key agreement with a simplex channel, in accordance with one embodiment of the present invention. A client 901 combines the client's secret code (S_{C}) with a monotonic nonce (T_{C}) to generate a code word (Σ_{C}), and submits the code word (Σ_{C}) to a selected hash algorithm (Hash_{C}) to produce a session key (H_{C}). Similarly, a server 903 combines the server's secret code (S_{S}), where (S_{S}=S_{C}), with the synchronized monotonic nonce (T_{S}), where (T_{S}=T_{C}), to generate a code word (Σ_{S}), and submits the code word (Σ_{S}) to a selected hash algorithm (Hash_{S}), where (Hash_{S}=Hash_{C}), to produce a session key (H_{S}). Because session keys are used in communication protocols, the client session key (H_{C}) and the server session key (H_{S}) should match for successful client-server communication. The implicit session key agreement method disclosed herein is useful for low-bandwidth networks of well-known peers because the shared secret is not transmitted in whole or part, and because the monotonic nonce is known in common among synchronized peers. Additionally, in one embodiment, a session key may be shared with one or more third-party network peers while retaining the privacy of the secret code word and all other session keys.

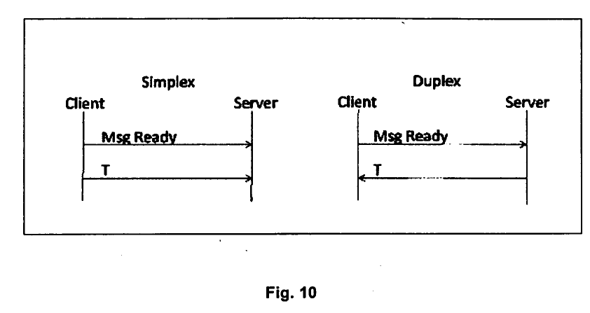

FIG. 10 shows a comparison of the simplex and duplex embodiments in the implicit session key agreement methods, in accordance with one embodiment of the present invention. In the simplex embodiment, the client explicitly synchronizes by producing the nonce (T) and providing it to the server. In the duplex embodiment, the server explicitly synchronizes by producing and sharing the nonce (T) as needed when the client is ready to transmit. The simplex embodiment may be used where simplex channels and/or excessive channel latency are present. The duplex embodiment may be used where the client cannot reliably produce a monotonic nonce and/or when the server can produce the nonce more conveniently and/or for less cost.

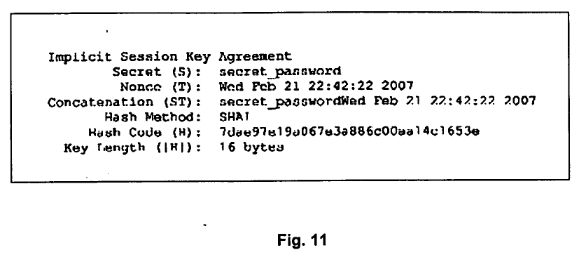

FIG. 11 shows an example implicit session key agreement implementation, in accordance with one embodiment of the present invention. In this embodiment, the secret code (S) is concatenated with the nonce code (T) to generate the code word (ST). Each symbol, i.e., code, is drawn from the set of {0 . . . 255} and may be ASCII or other coding for the convenience of the implementation. In this example, the code word (ST) is appended with 0's until the total length is 128 bits long. Then, the code word (ST) is submitted to the SHA-1 hashing algorithm to produce a 16-byte value for the hash code (H), where the hash code (H) represents the session key.

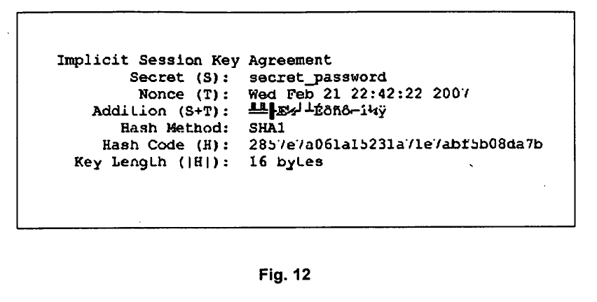

FIG. 12 shows another example implicit session key agreement implementation, in accordance with one embodiment of the present invention. In this embodiment, the nonce code (T) is added to the secret code (S), byte-by-byte (modulus 256). Each symbol, i.e., code, is drawn from the set of {0 . . . 255} and may be ASCII or other coding for the convenience of the implementation. In this example, the code word (S+T) is appended with 0's until the total length is 128 bits long. Then, the code word (S+T) is submitted to the SHA-1 hashing algorithm to produce a 16-byte value for the hash code (H), where the hash code (H) represents the session key.

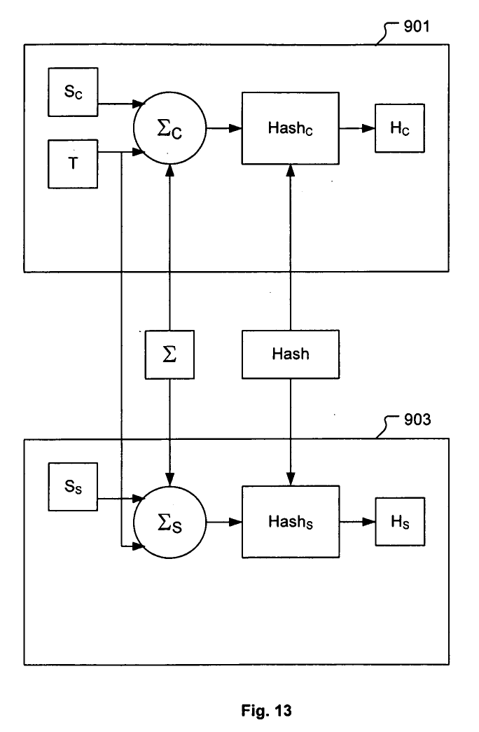

FIG. 13 shows an implicit session key agreement process with dynamic process parameters, in accordance with one embodiment of the present invention. The method (Σ) for combining the secret code (S) and the nonce code (T) is a dynamic parameter that can be set for both the client 901 and server 903. The hashing algorithm and associated parameters (Hash) is a dynamic parameter that can be set for both the client 901 and server 903.

The method for combining the secret code and the nonce code may be known a priori and encoded in the design of alternate embodiments, or it may be dynamically selected by information shared in common between the client and server. This information may be encoded within the message, implicit in the connection address or port number, or be conveyed by some other method, implicit or explicit. The method for combining the secret code and the nonce code should be identical between the client and server.

In one embodiment, the hashing algorithm is pre-defined. In other embodiments, the hashing algorithm may be known a priori and encoded in the design of alternate embodiments, or it may be dynamically selected by information shared in common between the client and server. This information may be encoded within the message, implicit in the connection address or port number, or be conveyed by some other method, implicit or explicit. The hashing algorithm should be identical between the client and server.

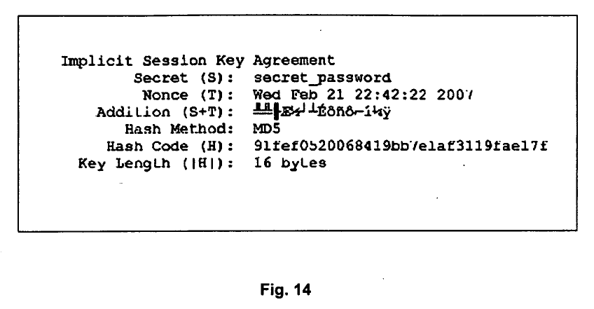

FIG. 14 shows an example in which the method of combination and hash algorithm are dynamically specified, in accordance with one embodiment of the present invention. In this embodiment, the secret code (S) and nonce code (T) are combined by bit-wise addition to generated the code word (S+T). Each symbol, i.e., code, is drawn from the set of {0 . . . 255} and may be ASCII or other coding for the convenience of the implementation. In this example, the code word (S+T) is appended with 0's until the total length is 128 bits long. Then, the code word (S+T) is submitted to the MD5 hashing algorithm to produce a 16-byte value for the hash code (H), where the hash code (H) represents the session key.

Based on the foregoing, it should be appreciated that the implicit session key agreement method provides for strong key agreement between a client and a server, where each possess a common secret code, and at a reduced communication channel bandwidth. Moreover, the implicit session key agreement method strongly secures distributed communication networks while minimizing the impact to overall communication channel bandwidth. Also, it should be appreciated that the session key (H) originates from a strong hash algorithm. Therefore, because the session key is generated from a mutual secret code and public nonce code, the mutual secret code cannot be practically deduced even if the session key is known. Additionally, the monotonic nonce ensures that the session key is not reused.

The implicit session key agreement methods discussed above can be implemented in many different ways. A number of exemplary embodiments are briefly identified below. It should be understood, however, that the generalized implicit session key agreement method as disclosed herein can be implemented in various ways that may not be explicitly identified in the exemplary embodiments below.

Implicit Session Key Agreement—Synchronized Channel

In this embodiment, both the client and server independently combine a shared secret and a monotonic nonce and submit the resulting code word to a hashing algorithm to obtain the session key. The monotonic nonce is inherently known to both the client and server and is not explicitly transmitted.

Implicit Session Key Agreement—Simplex Channel

In this embodiment, the monotonic nonce is produced by the client and is transmitted to the server. Both the client and server independently combine a shared secret and the monotonic nonce and submit the resulting code word to a hashing algorithm to obtain the session key.

Implicit Session Key Agreement—Duplex Channel

In this embodiment, the monotonic nonce is produced by the server and is transmitted to the client. Both the client and server independently combine a shared secret and the monotonic nonce and submit the resulting code word to a hashing algorithm to obtain the session key.

Implicit Session Key Agreement—Concatenated Codes, Synchronized Channel

This embodiment is like the synchronized channel embodiment above with the shared secret and monotonic nonce combined by concatenation, in any order, and with optional padding codes to obtain a canonical code length.

Implicit Session Key Agreement—Concatenated Codes, Simplex Channel

This embodiment is like the simplex channel embodiment above with the shared secret and monotonic nonce combined by concatenation, in any order, and with optional padding codes to obtain a canonical code length.

Implicit Session Key Agreement—Concatenated Codes, Duplex Channel

This embodiment is like the duplex channel embodiment above with the shared secret and monotonic nonce combined by concatenation, in any order, and with optional padding codes to obtain a canonical code length.

Implicit Session Key Agreement—Algebraic Codes, Synchronized Channel

This embodiment is like the synchronized channel embodiment above with the shared secret and monotonic nonce combined by algebraic operations including but not limited to addition, multiplication or division, in any order, and with optional padding codes to obtain a canonical code length.

Implicit Session Key Agreement—Algebraic Codes, Simplex Channel

This embodiment is like the simplex channel embodiment above with the shared secret and monotonic nonce combined by algebraic operations including but not limited to addition, multiplication or division, in any order, and with optional padding codes to obtain a canonical code length.

Implicit Session Key Agreement—Algebraic Codes, Duplex Channel

This embodiment is like the duplex channel embodiment above with the shared secret and monotonic nonce combined by algebraic operations including but not limited to addition, multiplication or division, in any order, and with optional padding codes to obtain a canonical code length.

Implicit Session Key Agreement—General Codes, Synchronized Channel

This embodiment is like the synchronized channel embodiment above with the shared secret and monotonic nonce combined by any operation with output dependent upon both the secret code and nonce, in any order, and with optional padding codes to obtain a canonical code length.

Implicit Session Key Agreement—General Codes, Simplex Channel

This embodiment is like the simplex channel embodiment above with the shared secret and monotonic nonce combined by any operation with output dependent upon both the secret code and nonce, in any order, and with optional padding codes to obtain a canonical code length.

Implicit Session Key Agreement—General Codes Duplex Channel

This embodiment is like the duplex channel embodiment above with the shared secret and monotonic nonce combined by any operation with output dependent upon both the secret code and nonce, in any order, and with optional padding codes to obtain a canonical code length.

Implicit Session Key Agreement—Dynamic Parameters

Any of the above-described embodiments can be implemented in a dynamic manner through specification/recognition of dynamic parameter settings including hashing parameters (including but not limited to the hashing algorithm and hash seed) and/or a particular secret code and nonce combination method. The dynamic parameter settings are transmitted or otherwise recognized by the client and server so that the client and server implementations dynamically match.

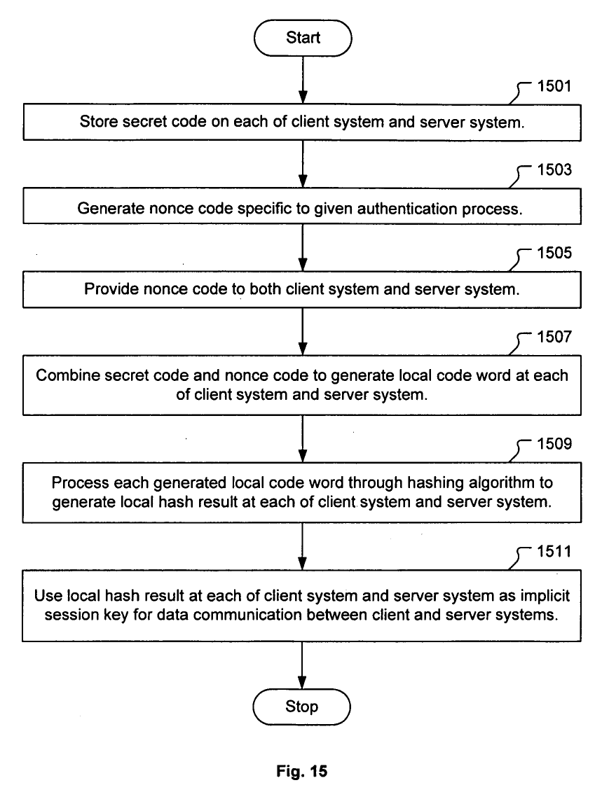

FIG. 15 shows a flowchart of a method for implicit session key agreement, in accordance with one embodiment of the present invention. The method includes an operation 1501 for storing a secret code on each of a client system and a server system. The secret code is identical on each of the client and server systems. The method also includes an operation 1503 for generating a nonce code specific to a given authentication process. In one embodiment, the nonce code is uniquely generated for each session based on a monotonically changing source. For example, in one embodiment, the nonce code is a time stamp. An operation 1505 is performed to provide the nonce code to both the client system and the server system. In one embodiment, providing the nonce code in operation 1505 includes generating the nonce code at the client system and transmitting the nonce code in public view from the client system to the server system. In another embodiment, providing the nonce code in operation 1505 includes generating the nonce code at the server system and transmitting the nonce code in public view from the server system to the client system.

The method further includes an operation 1507 for combining the secret code and the nonce code to generate a local code word at each of the client system and server system. In one embodiment, combination of the secret code and the nonce code is performed by either a concatenation or an algebraic combination and is performed in an identical manner at each of the client system and server system. The method also includes an operation 1509 for processing each generated local code word through a hashing algorithm to generate a local hash result at each of the client system and the server system. Additionally, an operation 1511 is performed to use the local hash result at each of the client system and the server system as an implicit session key for data communication between the client and server systems. In one embodiment, the method also includes an operation for specifying a common set of combination parameters and hashing parameters to be used at each of the client system and server system. The combination parameters can include identification of a method by which the secret code and the nonce code are to be combined to generate the local code word. The hashing parameters may include a hashing algorithm identification and a hash seed.

It should be understood that the invention described herein can be embodied as computer readable code on a computer readable medium. The computer readable medium is any data storage device that can store data which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network of coupled computer systems so that the computer readable code is stored and executed in a distributed fashion.

Any of the operations described herein that form part of the invention are useful machine operations. The invention also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data maybe processed by other computers on the network, e.g., a cloud of computing resources.

The embodiments of the present invention can also be defined as a machine that transforms data from one state to another state. The data may represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine.

While this invention has been described in terms of several embodiments, it will be appreciated that those skilled in the art upon reading the preceding specifications and studying the drawings will realize various alterations, additions, permutations and equivalents thereof. Therefore, it is intended that the present invention includes all such alterations, additions, permutations, and equivalents as fall within the true spirit and scope of the invention.

What is claimed is:

1. A method for performing a shortened hash authentication, comprising:
generating a first hash result at a client system in accordance with hash input parameters known to the client system;
generating a second hash result at a server system in accordance with hash input parameters known to the server system;
truncating each of the first hash result and the second hash result in a same manner;
transmitting the truncated first hash result from the client system to the server system; and
comparing the truncated first hash result as transmitted to the server system with the truncated second hash result generated at the server system, wherein equality between the truncated first hash result as transmitted to the server system and the truncated second hash result generated at the server system authenticates the client system to the server system.

2. The method of claim 1, wherein the hash input parameters known to the client system include a client code word representing a combination of a secret code and a nonce code as known to the client system, and wherein the hash input parameters known to the server system include a server code word representing a combination of a secret code and a nonce code known to the server system.

3. The method of claim 2, wherein the secret code known to the client system and the secret code known to the server system are identical and are stored on the client and server systems prior to authentication.

4. The method of claim 2, wherein the nonce code is uniquely generated for each authentication process.

5. The method of claim 4, wherein the nonce code is a time stamp.

6. The method of claim 4, further comprising:
generating the nonce code at the client system for use in the client code word; and
transmitting the nonce code from the client system to the server system for use in the server code word, wherein the nonce code is transmitted in public view.

7. The method of claim 4, further comprising:
generating the nonce code at the server system for use in the server code word; and
transmitting the nonce code from the server system to the client system for use in the client code word, wherein the nonce code is transmitted in public view.

8. The method of claim 4, further comprising:
generating the nonce code independently at each of the client system and server system, wherein the nonce code is generated based on identical information known to both the client system and server system such that the nonce code known to the client system is identical to the nonce code known to the server system.

9. The method of claim 2, wherein the secret code and the nonce code known to the client system are combined in either a concatenated manner or an algebraic manner to form the client code word, and wherein the secret code and the nonce code known to the server system are combined in same manner to form the server code word as used to form the client code word.

10. The method of claim 1, wherein both the first hash result and second hash result are generated using an identical hashing algorithm.

11. The method of claim 1, further comprising:
specifying a truncation size for both the first hash result and the second hash result, wherein the truncation size is specified based on a bandwidth available for transmission of the truncated first hash result and a probability of malevolent decoding of the truncated first hash result.

12. A method for performing a shortened hash authentication, comprising:
storing a secret code on each of a client system and a server system, wherein the secret code is identical on each of the client and server systems;
generating a nonce code specific to a given authentication process;
providing the nonce code to both the client system and the server system;
combining the secret code and the nonce code to generate a local code word at each of the client system and server system;
processing each generated local code word through a hashing algorithm to generate a local hash result at each of the client system and the server system;
at each of the client system and server system, truncating each local hash result to obtain a client-generated authentication code and a server-generated authentication code;
transmitting the client-generated authentication code to the server system; and
comparing the client-generated authentication code to the server-generated authentication code at the server system, wherein equality between the client-generated authentication code and the server-generated authentication code authenticates the client system to the server system.

13. The method of claim 12, wherein the nonce code is uniquely generated for each authentication process based on a monotonically changing source.

14. The method of claim 13, wherein the nonce code is a time stamp.

15. The method of claim 12, wherein providing the nonce code includes generating the nonce code at the client system and transmitting the nonce code in public view from the client system to the server system.

16. The method of claim 12, wherein providing the nonce code includes generating the nonce code at the server system and transmitting the nonce code in public view from the server system to the client system.

17. The method of claim 12, wherein combining the secret code and the nonce code is performed by either a concatenation or an algebraic combination and is performed in an identical manner at each of the client system and server system.

18. The method of claim 12, further comprising:
specifying a common set of hashing parameters and truncation parameters to be used at each of the client system and server system, wherein the hashing parameters include a hashing algorithm identification and a hash seed, and wherein the truncation parameters include a truncation length and a truncation offset.

19. A system for performing a shortened hash authentication, comprising:
a client defined to generate a first hash result in accordance with hash input parameters known to the client, and further defined to truncate the first hash result to obtain a client-generated authentication code;
a server defined to generate a second hash result in accordance with hash input parameters known to the server, and further defined to truncate the second hash result to obtain a server-generated authentication code;
wherein the client is defined to transmit the client-generated authentication code to the server, and
wherein the server is defined to receive the client-generated authentication code and compare the client-generated authentication code to the server-generated authentication code, wherein equality between the client-generated and server-generated authentication codes authenticates the client to the server.

20. The method of claim 19, further comprising:
a simplex communication connection between the client and the server, wherein the client is defined to generate and transmit a nonce code to the server, wherein the nonce code is a component of the hash input parameters for generating each of the first and second hash results.

21. The method of claim 19, further comprising:
a duplex communication connection between the client and the server, wherein the server is defined to generate and transmit a nonce code to the client, wherein the nonce code is a component of the hash input parameters for generating each of the first and second hash results.

22. The method of claim 19, a synchronized communication connection between the client and the server, wherein both the client and the server have access to a commonly known nonce code, wherein the nonce code is a component of the hash input parameters for generating each of the first and second hash results

23. A method for implicit session key agreement, comprising:
storing a secret code on each of a client system and a server system, wherein the secret code is identical on each of the client and server systems;
generating a nonce code specific to a given authentication process;
providing the nonce code to both the client system and the server system;
combining the secret code and the nonce code to generate a local code word at each of the client system and server system;
processing each generated local code word through a hashing algorithm to generate a local hash result at each of the client system and the server system; and
using the local hash result at each of the client system and the server system as an implicit session key for data communication between the client and server systems.

24. The method of claim 23, wherein the nonce code is uniquely generated for each session based on a monotonically changing source.

25. The method of claim 24, wherein the nonce code is a time stamp.

26. The method of claim 23, wherein providing the nonce code includes generating the nonce code at the client system and transmitting the nonce code in public view from the client system to the server system.

27. The method of claim 23, wherein providing the nonce code includes generating the nonce code at the server system and transmitting the nonce code in public view from the server system to the client system.

28. The method of claim 23, wherein combining the secret code and the nonce code is performed by either a concatenation or an algebraic combination and is performed in an identical manner at each of the client system and server system.

29. The method of claim 23, further comprising:
specifying a common set of combination parameters and hashing parameters to be used at each of the client system and server system, wherein the combination parameters include identification of a method by which the secret code and the nonce code are to be combined to generate the local code word, and wherein the hashing parameters include a hashing algorithm identification and a hash seed.
